(19) United States
(12) Patent Application Publication
(10) Pub. No.: US 2005/0261993 A1
(43) Pub. Date: Nov. 24, 2005

(54) Method and/or system for customer/vendor data management and analysis

(75) Inventor: Constantin Delivanis, Los Altos Hills, CA (US)

Correspondence Address: QUINE INTELLECTUAL PROPERTY LAW GROUP, P.C., P O BOX 458, ALAMEDA, CA, 94501, US

(73) Assignee: bDNA Corporation

(21) Appl. No.: 11/102,582

(22) Filed: Apr. 7, 2005

Related U.S. Application Data
(63) Continuation-in-part of application No. 10/125,952, filed on Apr. 18, 2002.
(63) Continuation-in-part of application No. 10/429,270, filed on May 2, 2003.
(60) Provisional application No. 60/560,771, filed on Apr. 7, 2004.

(51) Int. Cl. G06F 17/60; H04M 11/00

(52) U.S. Cl. 705/28; 709/223

(57) ABSTRACT

Methods and/or systems for managing information between a customer and a vendor, for example using the Internet. According to specific embodiments of the invention, for example, during a sales or service provision transaction, a vendor includes in a vendor maintained database various information about the products supplied to a customer. At the customer side, various utilization information is maintained about goods or services supplied. This information is then communicated to the vendor side where it can be stored, compared with other metrics, such as other customer data or expected utilization data, etc, which allows a vendor to provide various different sales and/or service opportunities to a customer.

### CROSS REFERENCE TO RELATED APPLICATIONS

This application claims priority from provisional patent application 60/560,771, filed 7 Apr. 2004 which is incorporated herein by reference in its entirety. This application is also a continuation-in-part of and claims priority from patent application Ser. No. 10/125,952, filed 18 Apr. 2002, entitled APPARATUS AND METHOD TO AUTOMATICALLY COLLECT DATA REGARDING ASSETS OF A BUSINESS ENTITY, and from patent application Ser. No. 10/429,270 filed 2 May 2003, entitled METHOD AND SYSTEM FOR FLEXIBLE DATA HANDLING, both of which are incorporated herein by reference in their entirety.

### COPYRIGHT NOTICE

Pursuant to 37 C.F.R. 1.71(e), Applicants note that a portion of this disclosure contains material that is subject to copyright protection (such as, but not limited to, source code listings, screen shots, user interfaces, or user instructions, or any other aspects of this submission for which copyright protection is or may be available in any jurisdiction.). The copyright owner has no objection to the facsimile reproduction by anyone of the patent document or patent disclosure, as it appears in the Patent and Trademark Office patent file or records, but otherwise reserves all copyright rights whatsoever.

### FIELD OF INVENTION

The present invention relates to systems and/or methods for data handling. More specifically, the invention in specific embodiments relates to a data method and/or system allowing one or more vendors to provide sophisticated information and/or analyses and/or verification to a customer relating to goods and/or services supplied by the vendor.

### BACKGROUND OF INVENTION

Large organizations that are purchasers of goods and/or services, generally are customers of one or more large vendors or suppliers. In the case of technical goods or services, such as information systems, the suppliers often desire to provide different types of services along with the basic equipment supplied, such as analysis of use, maintenance services, offerings of related and/or complementary products, etc.

However, as smaller information systems, such as PC's, printers, application programs, cellular phones, handheld devices, etc., have become more widely used and widely distributed by large organizations, it has become more difficult for a vendor to provide sophisticated levels of service and/or analysis to a customer regarding the status and/or cost of installed systems.

The Internet can be understood as a number of computers and computer networks that are interconnected through communication channels. Devices on the internet exchange information using electronic mail, HTTP, SHTTP, XML, etc. The internet has increasingly been recognized as a critical tool in business communications in recent years, including various business-to-business data exchanges. Many applications have been developed through which vendors and present and/or potential customers can exchange data regarding goods or services transacted.

### SUMMARY OF INVENTION

The present invention in specific embodiments is involved with and enables methods and/or systems allowing one or more vendors to maintain information about various goods and/or services supplied to and/or in use at one or more customer sites using data stores and/or data gathering at each site and data communication systems and methods. In particular embodiments, the invention is involved with and enables methods and/or systems for representing and/or managing and/or querying data at a vendor site that can be compared and/or updated with information from a customer site.

In specific embodiments, the present invention provides methods and/or systems enabling a vendor to initially input and store information regarding goods and/or services supplied to a customer (e.g., at the time of customer ordering or of delivery) and then, by communicating with a customer site via a communications medium to maintain and update information, including in real time, about installed goods and or services. The vendor's updated data store can then be used by the vendor to provide additional services and/or analysis to a customer as detailed herein.

In specific embodiments, data gathering at a customer site can be facilitated by using an automated IT discover system or methods, for example as described in coassigned patent application Ser. No. 10/125,952 referenced above and incorporated herein by reference. In other embodiments, data can be maintained and data structures modified at a vendor and/or customer site using a database system such as described in coassigned patent application Ser. No. 10/429,270 referenced above and incorporated herein by reference.

Thus, according to specific embodiments, the present invention involves methods and/or systems for managing information between a customer and a vendor, for example using the Internet. According to specific embodiments of the invention, for example, during a sales or service provision transaction, a vendor includes in a vendor maintained database various information about the products supplied to a customer. At the customer side, various utilization information is maintained about goods or services supplied, such as, for example, the amount of usage a computer device or application received, the number of pages printed by a printer, the amount of data stored on a storage device (such as a disk drive), the average amount and/or maximum amount of RAM used by a system, the amount of data transmitted on a network, etc. This information is then communicated to the vendor side through one or more communication interface modules where it can be stored, compared with other metrics, such as other customer data or expected utilization data, etc. The holding of this utilization type data on the vendor data side then allows a vendor to provide various different sales and/or service opportunities to a customer, such as analysis of utilization of resources, suggestions for upgrades and/or downgrades of various resources to optimize utilization, offers of additional and/or complementary goods and/or services in conjunction with existing services, identification of unutilized or underutilized resource, etc.

Various methods for data representation, data handling, data querying, data creating, and data reporting can be employed in specific embodiments of the invention. The invention can also be embodied as a computer system and/or program able to provide one or more data handling functions as described herein and/or can optionally be integrated with other components for capturing and/or preparing and/or displaying data such as bar code scanning systems, wireless inventory and/or tracking systems, network management systems, etc.

Various embodiments of the present invention provide methods and/or systems that can be implemented on a general purpose or special purpose information handling system using a suitable programming language such as Java, C++, Cobol, C, Pascal, Fortran, PL1, LISP, Perl, assembly, SQL, etc., and any suitable data or formatting specifications, such as HTML, XML, dHTML, tab-delimited text, binary, etc. In the interest of clarity, not all features of an actual implementation are described in this specification. It will be understood that in the development of any such actual implementation (as in any software development project), numerous implementation-specific decisions must be made to achieve the developers' specific goals and subgoals, such as compliance with system-related and/or business-related constraints, which will vary from one implementation to another. Moreover, it will be appreciated that such a development effort might be complex and time-consuming, but would nevertheless be a routine undertaking of software engineering for those of ordinary skill having the benefit of this disclosure.

The invention and various specific aspects and embodiments will be better understood with reference to the following drawings and detailed descriptions. For purposes of clarity, this discussion refers to devices, methods, and concepts in terms of specific examples. However, the invention and aspects thereof may have applications to a variety of types of devices and systems.

Furthermore, it is well known in the art that logic systems and methods such as described herein can include a variety of different components and different functions in a modular fashion. Different embodiments of the invention can include different mixtures of elements and functions and may group various functions as parts of various elements. For purposes of clarity, the invention is described in terms of systems that include many different innovative components and innovative combinations of innovative components and known components. No inference should be taken to limit the invention to combinations containing all of the innovative components listed in any illustrative embodiment in this specification.

When used herein, “the invention” should be understood to indicate one or more specific embodiments of the invention. Many variations according to the invention will be understood from the teachings herein to those of skill in the art.

### BRIEF DESCRIPTION OF DRAWINGS

FIG. 1 illustrates a block diagram of an example data systems environment in which various aspects according to specific embodiments of the invention can be deployed.

FIG. 2 illustrates one example of a display of a data structure for holding asset presence and usage data according to specific embodiments of the invention.

FIG. 3 illustrates an alternative example of a display of a data structure for holding asset presence and usage data according to specific embodiments of the invention.

FIG. 4 is a flow chart illustrating basic steps of collecting data at a vendor site and updating that data with customer data according to specific embodiments of the invention.

FIG. 5 is a flow chart illustrating basic steps of collecting data at a vendor site and providing customers with incentives for allowing usage and/or presence data at a customer site according to specific embodiments of the invention.

FIG. 6 is a flow chart illustrating example steps of using vendor and customer data at a vendor site to provide suggestions of additional services and/or goods to a customer site according to specific embodiments of the invention.

FIG. 7 is a block diagram showing a representative example logic device in which various aspects of the present invention may be embodied.

### DETAILED DESCRIPTION OF PREFERRED EMBODIMENT

Explanation of Certain Terms

The following term descriptions are provided here to further illustrate the invention in particular aspects. Definitions of terms here are not meant to be restrictive or exclude other understandings of terms that are consistent with and suggested by this application.

The term “asset” as used herein generally refers to any object or service that either a customer or vendor wishes to track. Assets can include tangible non-consumable goods, such as computers, printers, software applications, other office equipment, etc. Assets can, in some situations, also include non-tangible assets, such as licensing or service contracts. Assets can, in some situations, further also include consumable tangible goods such as paper, ink, etc. A tracked asset may be a part of other another asset. A computer system asset, for example, might include one or more tracked disk drives, cpu's, memory, software applications, and servicing contracts or licenses.

In specific embodiments, the present invention refers to automatic collection/discovery of asset data at a customer site. This data can generally be characterized as “presence data” and “utilization data.” Presence data indicates the presence of an asset at a customer site. Utilization data indicates something about the use of that asset.

While automatic discovery at its most simple might be understood as identifying the presence of specific hardware devices at a customer's site, it can also include discovery of the presence of other tangible and non-tangible assets. For example, a computer system can respond on a network and include information about the presence and/or use of various software applications, computer memory or disk drives, etc. A printer can report on the utilization of consumable resources such as ink or paper. A computer system might also record some information regarding software registration and/or licensing and thus can report the presence of some non-tangible assets such as software licenses. Strategies for collecting and storing these different types of data are discussed in the above referenced patent applications.

A database or data store as used herein indicates any type of either publicly available or proprietary information storage or retrieval system. Many such are known in the art. In a preferred embodiment, however, a customer and/or vendor side database will both be proprietary databases for recording information system assets, such as described in the above reference patent applications. The present invention, in specific embodiments, however, does not require a particular database system, nor does is require that the same database system be used at the customer and vendor site.

According to specific embodiments, the present invention can involve one or more analyses based on data captured at the vendor site and/or collected from the customer site. These analyses are not limited and can be provided using software and/or human analysis. These analyses can include such things as determining that assets supplied by a vendor do not register as present at a customer site, determining that particular assets are under-utilized or over-utilized, inferring from the presence and/or usage of certain assets that additional and/or different assets may be desireable.

According to specific embodiments of the invention, incentives may be provided to a customer to encourage a customer to share asset data with a vendor. Incentives may be such things as provision of usage and/or cost analysis by the vendor, assumption of responsibility by the vendor for determining that license terms are complied with, reduced cost of some goods and/or services provided to the customer, etc.

Overview

The invention provides methods and/or systems enabling effective multi-site communication between customer and vendor sites regarding, generally assets at a customer, some of which may have been provided by the vendor. By collecting and storing detailed customer asset data at a vendor site, the invention allows a vendor to provide more sophisticated analysis and/or to better offer services or complementary products. According to specific embodiments, the invention involves allowing a vendor to maintain accurate data regarding one or more customer sites automatically and/or in real time as assets are added or removed or modified at a customer location. The system of the present invention allows more efficient and effective interactions between vendors and customers, particularly regarding complex products and/or services, such as information technology products or services.

While the present invention will be described herein primarily using information system devices, software, or intangibles as assets, it will be understood to those of skill in the art that various other types of assets can be managed as described herein.

As just one example, a number of devices or systems which might not otherwise be consider information technology devices can incorporate information functions. For example, a softdrink dispensing machine can be included with additional components to allow information communication over a wired or wireless network, thus allowing the discovery of presence and/or utilization data of both the dispensing system and the drinks within to be collected an analyzed according to specific embodiments of the invention.

In further examples, inventor control systems are being developed that provide for information transmission at the shelf level and/or from the individual product, such as via a transponder tag. Again, methods of the invention that involve vendor side data input along with collection of presence and/or utilization data at a customer site, can be used in such an environment to provide a variety of inventory tracking functions.

Various previous methods have been attempted to allow a vendor to track and adequately service IT or other assets at a customer site. These methods have had several difficulties. For example, typically a vendor is not always sure what he has sold to a customer, particularly across product lines. Without a mechanism of combining information across product line sales it has been difficult to get a picture of this half of the equation. Second, the customer does not always notify the vendor when a particular piece of equipment is removed from service, moved to another location, put it in storage, or lost. Consequently, a manual process of accounting for sales to a given customer is often required to assess the level of purchases. While some newer resource management systems are beginning to help in this regard, on the customer side there is often no inventory available to the vendors, regardless of incentive that they might provide, since this inventory typically doesn't exist at the customer site. Further it is difficult for vendor and customer to cooperate to a level that would allow the required iterations of comparing vendor records to customer records. Since each of these accounting processes are error prone there needs to be a methodology to compare the two sets of data and iterating the process until the two data sets converge.

A further example of the problems that exist today is the use of customer tracking systems today. Because of the limited scalability of the systems the tracking of customers is done in a distributed fashion. The result is that there are often many identification numbers for a given customer contained in the vendors databases, making large picture of the customer-vendor relationship that much harder to create.

The present invention addresses these issues by taking information from all of these vendor systems and correlating it with the information from the customers into a complete view of the customer-vendor relationship.

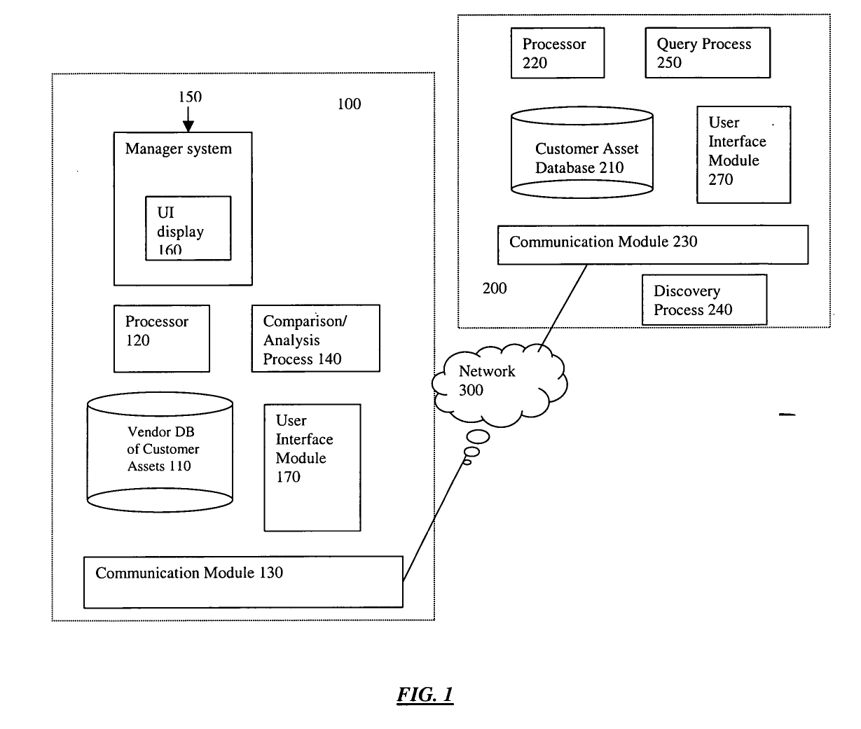

FIG. 1 illustrates a block diagram of an example data systems environment in which various aspects according to specific embodiments of the invention can be deployed. This example environment is provided to allow further understanding of the present invention and should not be taken to limit the interpretation of the claims. Those of skill in the art will recognize that many different system configurations/architectures can be an effective environment for the present invention. FIG. 1 illustrates a vendor system 100 and customer system 200 that communicate some data over a medium 300. The medium can be the world-wide internet or any other public or private communication channel that can transmit data.

System 100 can include a number of modules. These modules can in various embodiments be software and/or hardware components that are configured to operate together as will be commonly understood in the information processing art. An example of some such modules is discussed below, though different embodiments will have more or fewer modules and various functions can be grouped differently in different embodiments. Vendor database of customer assets 110 is a vendor-side data store that can store and retrieve asset data about one or more customers both that is collected by the vendor at the time of supplying the customer and that is updated from time to time by customer asset usage and presence data. A processor 120 can be understood as one or more data processor resources (such as CPUs) that can perform programmable logic functions. Communication module 130 can include software and/or hardware that allows the vendor system to make queries of and receive data from one or more customer systems and can provide other data communications. Comparison/analysis process 140 can, for example, include software routines and/or comparison data allowing the vendor system to make certain determinations regarding customer data. A manager system 150 that may be associated with a user interface display 160 and user interface module 170 will typically include software instructions providing such things as a command interface, reports, options settings, etc.

System 200 can also include a number of modules that can in various embodiments be software and/or hardware components that are configured to operate together as will be commonly understood in the information processing art. An example of some such modules is discussed below, though different embodiments will have more or fewer modules and various functions can be grouped differently in different embodiments. A customer database of customer assets 210 is a customer-side data store that can store and retrieve a customer's asset data. A processor 220 can be understood as one or more data processor resources (such as CPUs) that can perform programmable logic functions. Communication module 230 can include software and/or hardware that allows the customer system to communicate data with one or more vendor systems and can provide other data communications. Discover process 240 can be understood as a module that is used to automatically collect presence and/or utilization data from various assets at a customer site, such as from information appliances 280. A user interface module 270 will typically include software instructions providing such things as a command interface, reports, options settings, etc. for a customer. Included in these options typically will be some data input allowing a customer to specify which data fields can be shared with which vendors.

Data Store

In one embodiment, the invention utilizes a database at a vendor site for initially storing data regarding assets supplied to one or more customers. This data can include data that initially is input by the vendor, for example at the time of sale. The invention then utilizes one or more data interfaces for updating the information regarding the customer installation. Such communication can include data exchange with a database maintained at a customer site and/or can include, for example, direct communication with one or more IT devices at a customer site. Typically, the information will include real-time or near real-time data regarding customer utilization of IT or other resources.

In specific embodiments, a vendor side data system assigns or determines a unique identifier for each communicating system assigned to a customer. In doing this, the invention can utilize one or more digital fingerprint techniques, such as discussed in above referenced patent applications. Thus, the vendor data system stores data about customer systems that is input by the vendor and also data that is collected from use of IT devices.

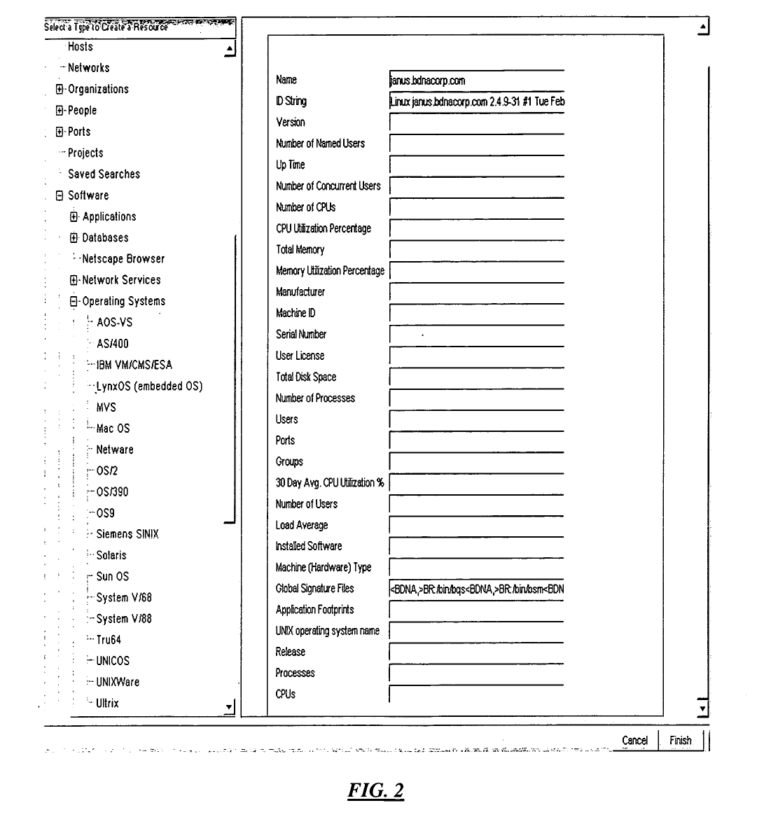

Thus, in specific embodiments the invention provides a method of managing data regarding goods and/or services supplied by a vendor to a customer that utilized a vendor database on a first information system regarding goods and/or services supplied to said customer. This vendor database, in one example, can have a field list and organization generally as shown in FIG. 2. However, other data structures are possible according to specific embodiments of the invention.

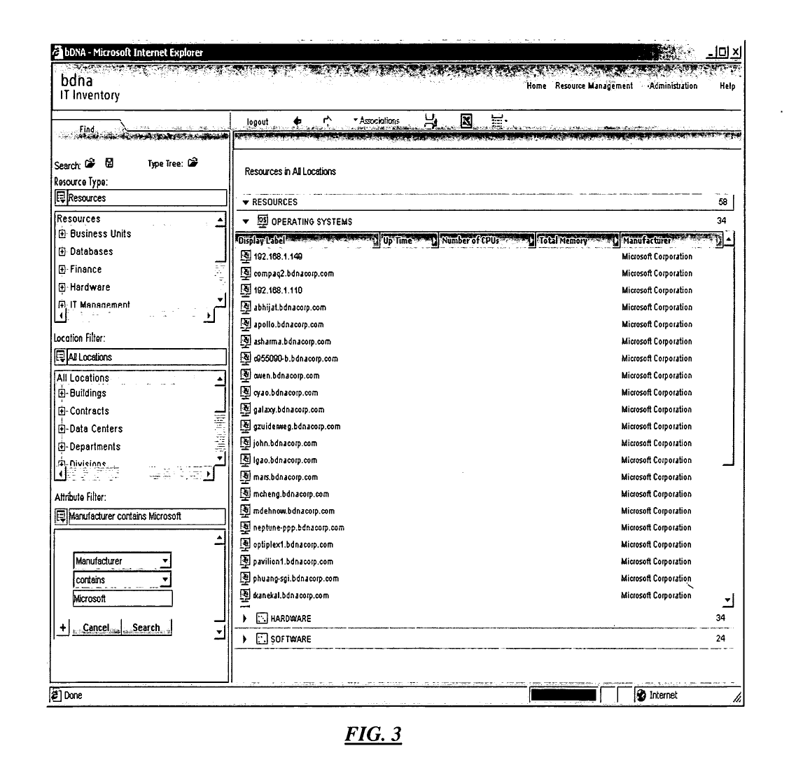

According to the invention, a separate database is maintained under control of a customer on a different second information system regarding use of goods and/or services supplied by the vendor. This database may have the same or a different structure, as indicated by FIG. 2. A list of asset items can be displayed and/or searched as illustrated by the example display shown in FIG. 3.

According to specific embodiments of the invention, the vendor and customer databases are configured to pass data objects and/or messages over a communication medium so that the vendor database, in particular, can be updated with information regarding the customer installations, for example information related to assets added to or removed from the customer's site or various utilization data.

This allows a vendor to maintain more complete information about goods or services provided at a customer site and to develop software and/or other techniques to provide additional information and/or value to a customer. For example, a vendor using the invention can determine how better to service products supplied to a customer.

Where goods and/or services comprise information systems services, automatic collection of customer data may be facilitated by each information system having an identification at a customer network allowing automatic tracking and/or inventorying in the customer database.

Example of Database Matching

The present invention, in further embodiments, involves one or more methods of utilizing vendor collected data about customer installations. As an example, let Customer B represent a large customer that has a global IT infrastructure of heterogeneous makeup. Using present methods, it is difficult or impossible for a Vendor A to create leasing agreements that include various features, such as a repurchase of all or a substantial portion of existing equipment at the customer site. In large or complex installations, tracking leases of new equipment at all can be very difficult.

Using a system according to specific embodiments of the invention at the customer site and/or at the vendor site, a customer can discover and track items from a particular vendor and pass that data back to that vendor. The vendor can then match the customer data against vendor records of sales to that customer. In this circumstance the vendor can, for example, create a large scale leasing arrangement that has significant financial implications to the customer. The present invention facilitates such an arrangement by allowing a vendor and customer to share and/or compare detailed inventory information including location information, age, and the sale records of the vendor.

Under such a leasing arrangement, replacement or upgrade of obsolete systems can be performed with the ongoing assistance of or at the direction of the vendor. The present invention according to specific embodiments allows this by creating at the vendor site a central awareness of the state of a given piece of equipment both at the time of purchase and during use, possibly long after purchase. Thus, asset utilization can be optimized as part of the vendor's service to its customers.

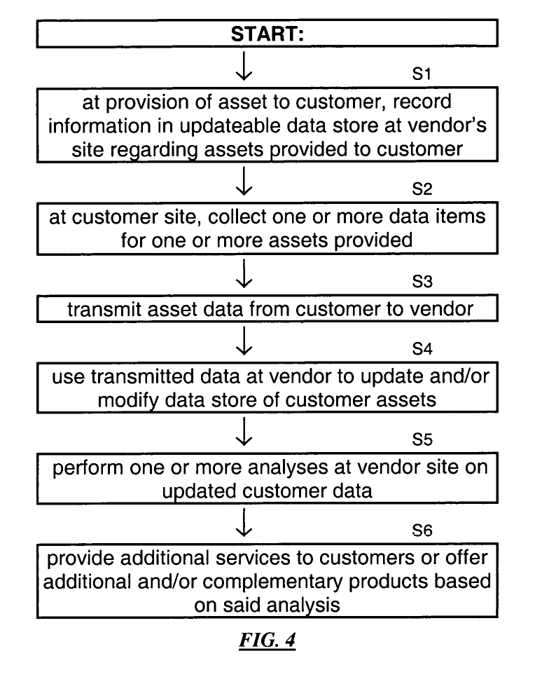

FIG. 4 is a flow chart illustrating basic steps of collecting data at a vendor site and updating that data with customer data according to specific embodiments of the invention.

In some instances, the invention provides a means to further utilize data entered into a vendor database during a sales and/or supplying transaction. One type of further utilization would be to provide to a customer as a result of data comparing, analyses regarding whether said goods and/or services are being used optimally and might further allow a vendor to suggest one or more offers of additional or substitute goods and/or services to a customer. Additionally, according to specific embodiments of the invention a customer can be provided verification that supplied goods and/or services have been installed and/or are operational or an analyses of maintenance needs of said goods and/or services. Another type of result supplied to customers could be analyses of total costs of selected sets of goods and/or services.

Further Examples: Upsell and Advanced Customer Analysis

A further example of the advantage of using a system according to specific embodiments of the invention is demonstrated by the case of a vendor up-sell. This occurs when an opportunity to better service a customer arises from the knowledge a vendor has of the current situation that exists at a customer site. A vendor-side analysis, for example, can improve efficiency or performance of an environment that already contains some products of the vendor but could benefit from further introduction of the vendor's products.

As a specific example, consider a situation where vendor side data shows that a customer has purchased a large number of low end disk arrays, with performance options, for a customer's server farm. The servers themselves may have been purchased some time ago, and the performance options purchased on the arrays indicate that they are tied to the servers. The inventory data that is received from the customer will include servers and disk arrays and options purchased from the vendor denoting a large trend toward a server farm architecture being implemented. Analysis performed at the vendor side, possibly by software analytics running on a vendor system, may suggest that several additional products and/or services that are not being used at the customer site might be of further benefit to this customer. For example, analysis may indicate that there are no Storage Area Network (SAN) switches that are installed or have been purchased at the customer site. The vendor may be aware, though the customer may not, that such SAN switches could dramatically improve usability and data management of the server farm environment. This would alert the vendor that there is a likely prospect for sale of these products to improve the customer's operation. As a further example, analysis can also indicate that in such an environment there is an opportunity to improve performance dramatically with the addition of storage virtualization and caching hardware and software.

Thus, according to specific embodiments of the invention, additional opportunities are given for a vendor not only to “up-sell” additional products into the account but also to bundle service and support offerings, leveraging the vendors ability to provide and/or service additional assets to the customer as creating a bigger and better long term relationship with the customer.

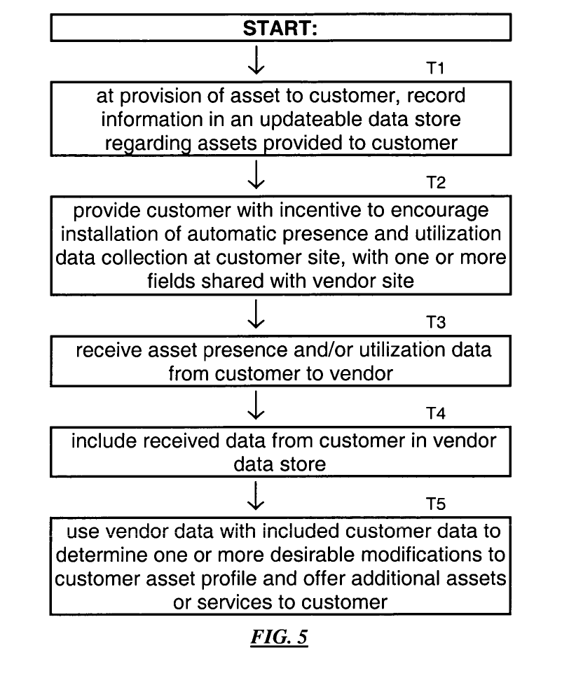

FIG. 5 is a flow chart illustrating basic steps of collecting data at a vendor site and providing customers with incentives for allowing usage and/or presence data at a customer site according to specific embodiments of the invention.

Further Example: License Management

Another class of “up-sell” available to the vendor according to specific embodiments of the invention can be services such as license or service plan management for vendor supplied assets or other assets. Enterprises spend significant amounts of money simply attempting to audit their license compliance to vendor license agreements. According to specific embodiments of the invention, a vendor can offer to do the license management itself, thereby potentially relieving a customer of the responsibility, liability, and/or expense associated with license compliance. In further embodiments, a vendor's ability to provide license management services can be used as an incentive to encourage a customer to allow the vendor to have access to the customers inventory data. In other embodiments, a vendor may offer financial incentives, such as discounts, to encourage a customer to provide access to the customer's inventory data.

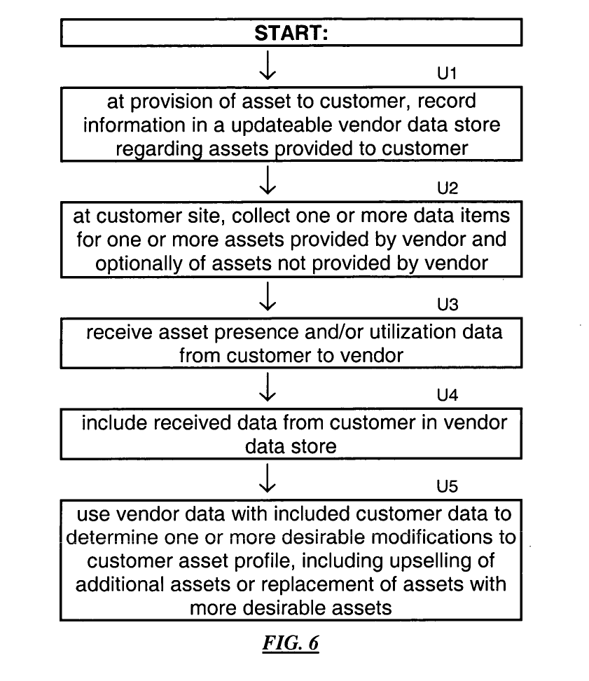

FIG. 6 is a flow chart illustrating example steps of using vendor and customer data at a vendor site to provide suggestions of additional services and/or goods to a customer site according to specific embodiments of the invention.

Example of Data Fields

The specific types of data that are maintained at either the customer side or the vendor side of a system or method according to specific embodiments of the invention can vary. Different implementations may include different types of data and different fields may be kept for different devices or resources that are monitored and/or sold and tracked according to the invention.

The invention may be better understood, however, by considering a specific example. In this example, the data relates to IT resources, such as computer devices. Table 1 indicates data that is maintained at a vendor side, and provides an indication of data fields that may be entered at initial sale or provision of the device to a customer and data fields that may be updated from data received from the customer site. Table 2 indicates example data that may be maintained at the customer site and includes example indications of data that may be shared with the vendor as well as data that is not shared.

According to specific embodiments of the invention, the data consists of one or more itemized lists of specific hardware (HW) and/or software (SW) components on the customer network that were supplied by that vendor. With each item there is a list of information about the usage of that item in the users environment. A specific example data structure maintained at the customer side might look like that shown in Table 1.

TABLE 1
Customer Side Data

| | | | | Example |
|---|---|---|---|---|
| | | | | Shared |
| Field Name | | | Example Value | Status |
| 1. | Item name product description | | janus.bdnacorp.com | Shared |
| 2. | date of initial usage at | | 1 Jan. 2001 | Shared |
| | customer site | | | |
| 3. | utilization information | | 63% | Shared |
| | a. | Size of application | 48.5 Meg/22% | Shared |
| | | data sets | | |
| | b. | Number of users | 8 | Optionally |
| | | | | Not Shared |
| | c. | High water marks | 85% | Shared |
| | | (peak utilization) | | |

| | | | |
|---|---|---|---|
| 4. | Basic configuration | Lynx | Shared |
| | information | | |
| 5. | Applications deployed upon | Oracle, Excel, | Shared |
| | HW or in conjunction with SW | Word, | |
| 6. | Specific options deployed | | Shared |
| 7. | Geographic location of device | Bldg. 200 | Optionally |
| | or application | | Not Shared |
| 8. | Other license options or | Oracle Service | Optionally |
| | products associated with this | License # 987 | Not Shared |
| | item | | |

At the vendor side, data is also maintained for example from the point of the initial sale. An example of vendor side data in shown in Table 2.

TABLE 2
Vendor Side Data

| Field Name | | Example Value |
|---|---|---|
| 1. | item name, item number, product | Lynx |
| | description | Workstation |
| 2. | number of items (for each) | 45 |
| | purchased by specific customer | |
| 3. | Expected utilization information | 55% |
| | (based on analytics done by | |
| | vendor) | |
| 4. | Expected configuration | Lynx |
| 5. | Possible applications deployed | Oracle; |
| | with this item | |
| 6. | Options available with this item | 200 GB Disk; |
| | | 350 GB Disk |
| 7. | Obsolescence data | 18 months |

Data Exchange

Data exchange between the customer and the vendor can take place using any communication and data exchange technology. In one example, the entire shared data record for every item at a customer site can be compressed and encrypted and transmitted over a communication channel, such as the Internet, to the vendor site, where the data can be unpacked and compared with the data records stored at the vendor site.

Vendor Side Analysis

According to specific embodiments of the invention, a vendor system can perform an intelligent match and analysis between vendor side data and customer data. One example of such an analysis is as provided below. In this example, a vendor analysis can proceed as follows:

| 1. | Look up item on vendor system based on customer data. | |
|---|---|---|
| | a. | Compare each item to verify match and track or log |
| | | discrepancies. |

| | |
|---|---|
| i. | For any item not known to vendor but at the customer site, |
| | flag that item to perform an analysis of where the item |
| | came from. |
| ii. | For any item believed by vendor to be present at customer |
| | site, but not indicated as present by customer update data, |
| | flag that item to perform an analysis of what became of the |
| | item. |

| 2. | For each item type discovered at customer site perform analyses such | |
|---|---|---|
| | as: | |
| | a. | Is the item configuration optimal and/or correct? |

| | |
|---|---|
| i. | If not, determine if customer should be notified of |
| | improvement options. |

| | |
|---|---|
| b. | Compare logged utilization with expected utilization. |

| | |
|---|---|
| i. | Determine if items are not being used properly. |
| ii. | Determine if items are about to break and new products are |
| | needed. |

| | |
|---|---|
| c. | Compare Software Applications deployed to application data |
| | maintained at vendor site. |

| | |
|---|---|
| i. | Are unqualified applications being depended upon? |
| ii. | Are there additional or substitute applications that may be |
| | desirable? |

| | |
|---|---|
| d. | Compare dates of customer systems to obsolescence data at |
| | vendor. |

| | |
|---|---|
| i. | Do support/service contracts need to be renewed? |
| ii. | Does the customer have sufficient service contracts and/or |
| | assets to cover needs? |

| 3. | Create a list of Discrepancies and/or Opportunities | |
|---|---|---|
| | a. | Perform license audit. |
| | b. | Create a list of actions for the specific customer for vendor sales |
| | | and/or support. |

Further Examples

As a further example, consider Vendor A, a large information technology supplier. In general, Vendor A is interested in understanding how to service their products that are supplied to another company, such as Customer B, which is an international supplier of office goods and services. In such a situation, both sides of the relationship could use a proprietary asset tracking system, such as discussed herein, or just Vendor A might. In any case, Vendor A would initially collect data regarding what they had sold to Customer B. The present invention, in this case, for example, would allow the vendor to have better visibility into the performance at their various customer sites that would allow a critical feedback link to enable a vendor to do a better job.

Embodiment in a Programmed Information Appliance

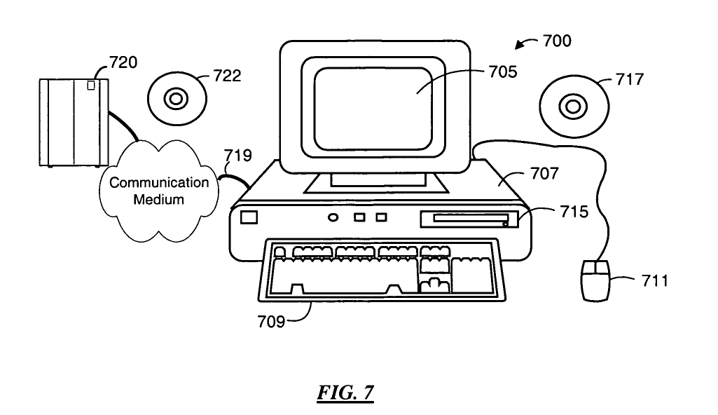

FIG. 7 is a block diagram showing a representative example logic device in which various aspects of the present invention may be embodied. As will be understood to practitioners in the art from the teachings provided herein, the invention can be implemented in hardware and/or software. In some embodiments of the invention, different aspects of the invention can be implemented in either client-side logic or server-side logic. As will be understood in the art, the invention or components thereof may be embodied in a fixed media program component containing logic instructions and/or data that when loaded into an appropriately configured computing device cause that device to perform according to the invention. As will be understood in the art, a fixed media containing logic instructions may be delivered to a user on a fixed media for physically loading into a users computer or a fixed media containing logic instructions may reside on a remote server that a user accesses through a communication medium in order to download a program component.

FIG. 7 shows an information appliance (or digital device) 700 that may be understood as a logical apparatus that can read instructions from media 717 and/or network port 719, which can optionally be connected to server 720 having fixed media 722. Apparatus 700 can thereafter use those instructions to direct server or client logic, as understood in the art, to embody aspects of the invention. One type of logical apparatus that may embody the invention is a computer system as illustrated in 700, containing CPU 707, optional input devices 709 and 711, disk drives 715 and optional monitor 705. Fixed media 717, or fixed media 722 over port 719, may be used to program such a system and may represent a disk-type optical or magnetic media, magnetic tape, solid state dynamic or static memory, etc. In specific embodiments, the invention may be embodied in whole or in part as software recorded on this fixed media. Communication port 719 may also be used to initially receive instructions that are used to program such a system and may represent any type of communication connection.

The invention also may be embodied in whole or in part within the circuitry of an application specific integrated circuit (ASIC) or a programmable logic device (PLD). In such a case, the invention may be embodied in a computer understandable descriptor language, which may be used to create an ASIC, or PLD that operates as herein described.

Other Embodiments

The invention has now been described with reference to specific embodiments. Other embodiments will be apparent to those of skill in the art. In particular, a viewer digital information appliance has generally been illustrated as a personal computer. However, the digital computing device is meant to be any information appliance for interacting with a remote data application, and could include such devices as a digitally enabled television, cell phone, personal digital assistant, laboratory or manufacturing equipment, etc. It is understood that the examples and embodiments described herein are for illustrative purposes and that various modifications or changes in light thereof will be suggested by the teachings herein to persons skilled in the art and are to be included within the spirit and purview of this application and scope of the claims.

Thus, the described embodiments of the invention are provided as illustrations and descriptions. They are not intended to limit the invention to precise form described. In particular, the Applicant contemplates that functional implementation of invention described herein may be implemented equivalently in hardware, software, firmware, or other available functional components or building blocks. Furthermore, the specific discussions of database types is not meant to preclude the possibility that the current invention may use, manage and/or operate on one or more different varieties of data storage or management. Other variations and embodiments are possible in light of above teachings, and it is thus intended that the scope of invention not be limited by this detailed description.

All publications, patents, and patent applications cited herein or filed with this application, including any references filed as part of an Information Disclosure Statement, are incorporated by reference in their entirety.

1. A method of managing data regarding goods and/or services supplied by a vendor to a customer comprising:
under control of said vendor, maintaining a vendor database on a first information system regarding goods and/or services supplied to said customer;
under control of said customer, maintaining a customer database on a second information system regarding use of goods and/or services supplied by said vendor;
updating said vendor database using said customer database by passing data objects and/or messages over a communication medium; and
at said vendor site, performing one or more analyses based on an updated vendor database.

2. The method of claim 1 further comprising:
storing in said vendor database information from said customer data base received over said communication medium.

3. The method of claim 1 further wherein:
said customer database comprises data regarding status and/or usage of goods and/or services that is collected automatically over a customer network.

4. The method of claim 1 further wherein:
said vendor database comprises data that is entered during a sales and/or supplying transaction.

5. The method of claim 1 further wherein:
said communication medium comprises secure communication over a shared public network.

6. The method of claim 1 further wherein:
said goods and/or services comprise information systems services.

7. The method of claim 1 further wherein:
said goods comprise a plurality of information systems, at least some such systems having an identification at a customer network allowing automatic tracking and/or inventorying in said customer database.

8. The method of claim 1 further comprising:
providing to a customer one or more analyses regarding whether said goods and/or services are being used optimally.

9. The method of claim 1 further comprising:
providing to a customer based on said analyses, one or more offers of additional goods and/or services.

10. The method of claim 1 further comprising:
providing to a customer based on said analyses, one or more offers of substitute goods and/or services.

11. The method of claim 1 further comprising:
providing to a customer verification that supplied goods and/or services have been installed and/or are operational.

12. The method of claim 1 further comprising:
providing to a customer one or more analyses of maintenance needs of said goods and/or services.

13. The method of claim 1 further comprising:
providing to a customer one or more analyses of total costs of selected sets of goods and/or services.

14. The method of claim 1 further wherein:
said vendor database and said customer database are of substantially the same design.

15. The method of claim 1 further wherein:
assets supplied by a plurality of vendors are tracked by said customer database and a plurality of customer's assets are tracked by said vendor database.

16. The method of claim 1 further wherein:
said customer is a governmental entity and information about products and vendors used in said customer databases is published openly to allow vendors to create an open market for said customer's needs.

17. A system able to manage goods and/or services provided by a vendor to a customer comprising:
a vendor database on a first information system regarding goods and/or services supplied to said customer;
a communication system at said vendor database;
a customer database on a second information system regarding goods and/or services used by said customer;
a communication system at said customer database;
a data passing protocol for securely passing information between said customer database and said vendor database;
an analysis module at said vendor database for analyzing comparisons between said vendor database and said customer database.

18. A computer readable medium containing computer interpretable instructions describing a circuit layout for an integrated circuit that, when constructed according to said descriptions, will configure a circuit to embody the apparatus described in claim 17.

19. A computer readable medium containing computer interpretable instructions that when loaded into an appropriately configuration information processing device will cause the device to operate in accordance with the method of claim 1.
